(19) United States
(12) Patent Application Publication
(10) Pub. No.: US 2007/0100521 A1
(43) Pub. Date: May 3, 2007

(54) Reporting information related to a vehicular accident

(76) Inventor: Eric Grae, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/263,764

(22) Filed: Oct. 31, 2005

(51) Int. Cl. G06F 19/00

(52) U.S. Cl. 701/35; 340/438

(57) ABSTRACT

An aspect of the present invention includes a method of reporting information related to a vehicular accident wherein the vehicular accident involves at least one vehicle. The method includes capturing images of the vehicular accident with an image capturing device in response to an event trigger in a real time fashion and transmitting the images to a database.

### FIELD

The present invention relates generally to the insurance industry and more particularly to a method and system for reporting information related to a vehicular accident.

### BACKGROUND

In the United States, automobile insurance companies deal with thousands of vehicular accident claims each year. These accidents involve drunk drivers, hit and run situations, speeding vehicles etc. Insurance companies then settle or litigate these claims based on which driver was at fault. However the determination of fault is sometimes calculated based on incomplete information.

Many times after an accident, the vehicles have to be quickly moved off the road. Accordingly, the accident information is typically gathered by hand with police reports, exchanges of information between drivers, etc. Sometimes accident reconstruction experts are also brought in to determine which driver was at fault. Because the vehicles usually have to be moved immediately after the accident, the information gathered is invariably inaccurate. This inaccurate information leads to many expensive trials and legal battles. Consequently, these costs are ultimately passed onto the consumer through higher insurance premiums.

Accordingly, what is needed is a method and system that is capable of recording information related to vehicular accident in a more accurate fashion. The inventive concepts described herein address this need.

### SUMMARY

An aspect of the present invention includes a method of reporting information related to a vehicular accident wherein the vehicular accident involves at least one vehicle. The method includes capturing images of the vehicular accident with an image capturing device in response to an event trigger in a real time fashion and transmitting the images to a database.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method in accordance with an embodiment of the present invention.

FIG. 2 is an illustration of a system for recording data related to a vehicular accident in accordance with an embodiment of the present invention.

FIG. 3 shows a more detailed illustration of a personal computer that could be utilized in conjunction with an embodiment of the present invention.

FIG. 4 shows a high level illustration of a digital camera in accordance with an embodiment of the present invention.

FIG. 5 shows a detailed block diagram of an imaging device in accordance with an embodiment of the present invention.

FIG. 6 shows a GPS in accordance with an embodiment of the present invention.

FIG. 7 is a flowchart of the operation of the system in accordance with an embodiment of the present invention.

FIG. 8 shows a vehicular accident reporting module in accordance with an embodiment of the present invention.

FIG. 9 is a flowchart of an alternate embodiment of the present invention.

### DETAILED DESCRIPTION

The present invention relates to a system and method of recording data related to a vehicular accident. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

Based on varying embodiments of the present invention, a system and method of recording data related to a vehicular accident are disclosed. As a result, vital data and images of a vehicular accident are expeditiously recorded in real time and with high resolution. Consequently, a more accurate account of the vehicular accident is generated thereby resulting in less accident related litigation for insurance companies. This translates to lower insurance premiums for the consumer.

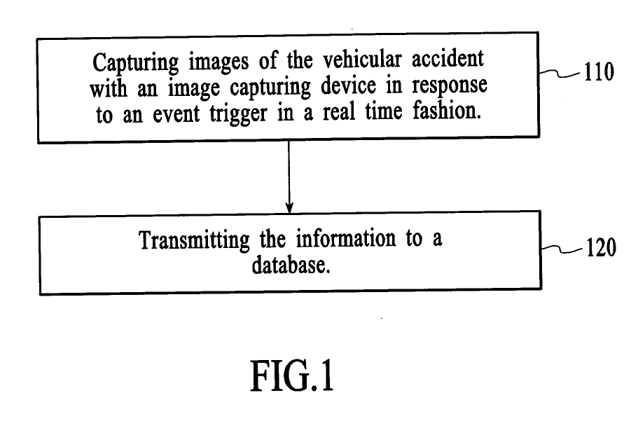

FIG. 1 shows a high-level flowchart of a method in accordance with an embodiment. A first step 110 involves capturing images of the vehicular accident with an image capturing device in response to an event trigger in a real time fashion. A second step 120 involves transmitting the images to a database.

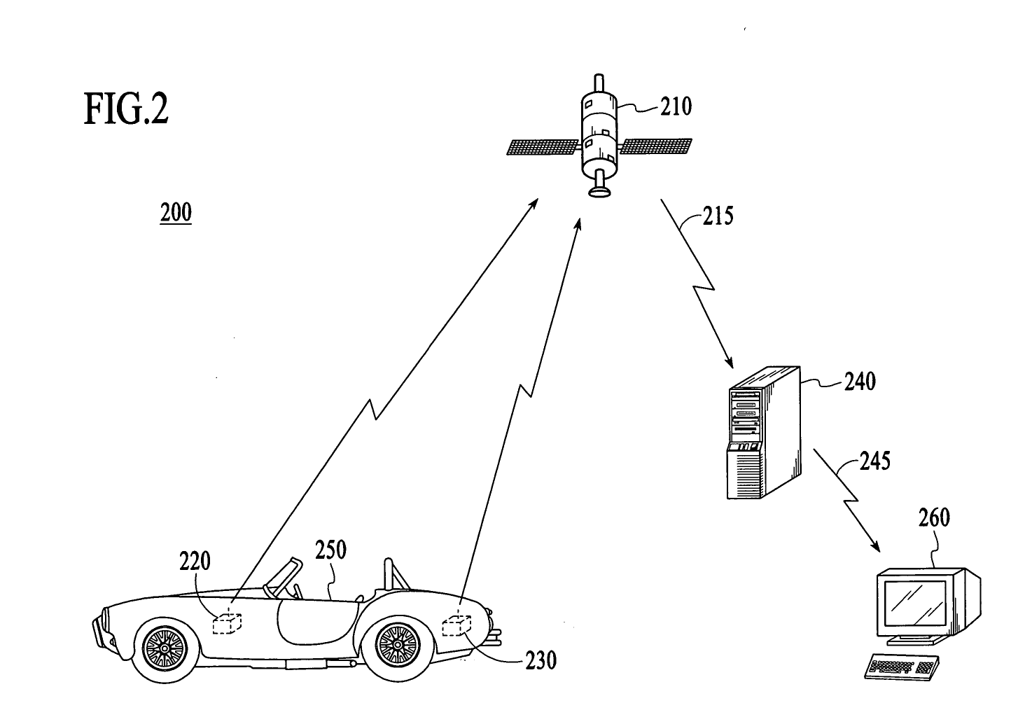

FIG. 2 is an illustration of a system 200 for recording data related to a vehicular accident in accordance with an embodiment. The system 200 includes a data capturing system 210, an impact sensory system 220, a global positioning system (GPS) 230 and a database 240. In an embodiment, the impact sensory system 220 and the GPS 230 are located in a vehicle 250 whereby the impact sensory system 220 and the GPS 230 are both capable of transmitting signals to and receiving signals from the data capturing system 210. Additionally, the data capturing system 210 is capable of communicating with the database 240 via a satellite communications link 215 whereby the database 240 is coupled to client system 260 via communications network 245.

In an embodiment, the database 240 is a server whereby the server and the client system 260 operate in a client/server environment. The term “server” may refer to both the hardware and software (the entire computer system) or just the software that performs the service. For example, Web server may refer to the Web server software in a computer that also runs other applications, or, it may refer to a computer system dedicated only to the Web server application. For example, a large Web site could have several dedicated Web servers or one very large Web server.

In an embodiment, the server is a database server. A database server is a computer in a local area network (LAN) dedicated to database storage and retrieval. It holds a database management system (DBMS) and the associated databases. Upon requests from the client machine(s), it searches the database for selected records and passes them back over the network.

A typical client/server environment involves an architecture in which the client (e.g. a PC) is the requesting machine and the server is the supplying machine, both of which are connected via a communications network such as a LAN or wide area network (WAN). Additionally, in a client/server relationship, the client processes the user interface (e.g. Windows) and can perform some or all of the application processing. Servers range in capacity from high-end PCs to mainframes.

In an embodiment, the communications network 245 is the Internet. The Internet, which is a global web of interconnected computers and computer networks, integrates local area networks (LANs) located in various entities, such as businesses, libraries, federal agencies, institutes of learning, and research organizations into a single communication network. The Internet uses a common communication protocol suite, known as a Transmission Control Protocol/Internet Protocol (TCP/IP), which was specifically designed for the interconnection of different computer systems. Internal and external networks are linked by routers that route data packets from a sending network to another router or a receiving network. Gateways handle data transfer and conversion of messages from a sending network to the protocols used by a receiving network. Typically, gateways refer to devices that translate between applications. For example, e-mail gateways translate messages from one vendor's messaging program to another vendor's messaging program so that users with different e-mail programs can share messages over a network.

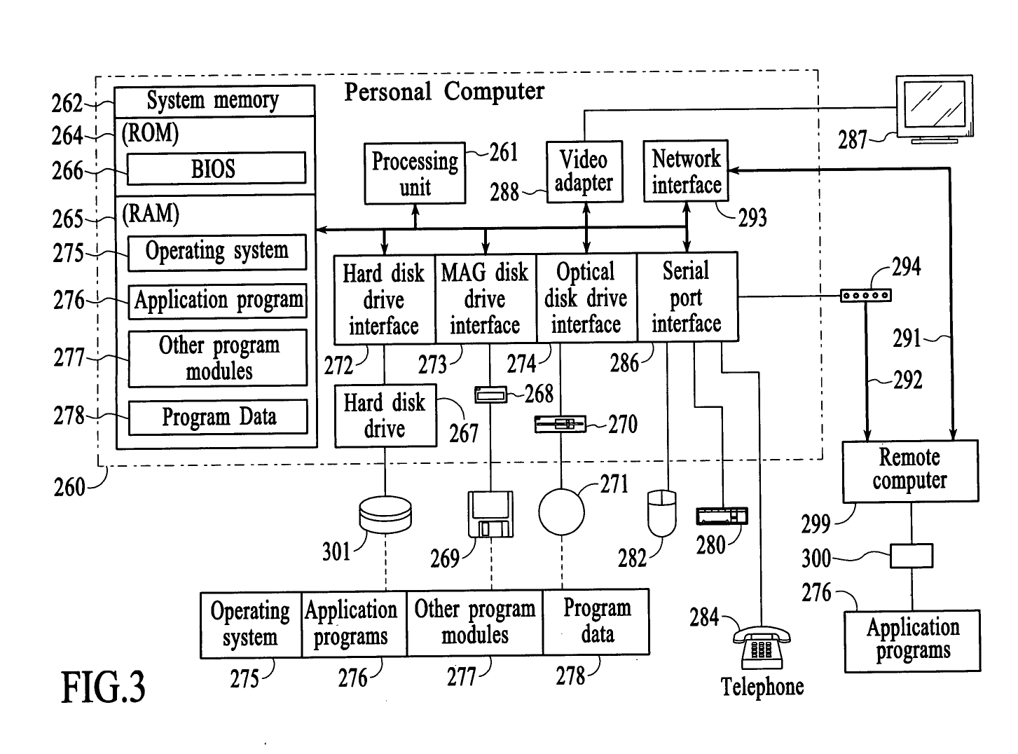

As mentioned above, in an embodiment, the client system 260 is a personal computer (PC). With reference to FIG. 3, an exemplary personal computer 260 for implementing an embodiment includes a processing unit 261, a system memory 262, and a system bus 263 that couples various system components including the system memory to the processing unit 261. The system bus 263 may be any of several types of bus structures including a memory bus or memory controller, a peripheral bus, and a local bus using any of a variety of bus architectures. The system memory includes read only memory (ROM) 264 and random access memory (RAM) 265. A basic input/output system (BIOS) 266, containing the basic routines that help to transfer information between elements within the personal computer 260, such as during start-up, is stored in ROM 264. The personal computer 260 further includes a hard disk drive 267 for reading from and writing to a hard disk, not shown, a magnetic disk drive 268 for reading from or writing to a removable magnetic disk 269, and an optical disk drive 270 for reading from or writing to a removable optical disk 271 such as a CD ROM or other optical media.

The hard disk drive 267, magnetic disk drive 268, and optical disk drive 270 are connected to the system bus 263 by a hard disk drive interface 272, a magnetic disk drive interface 273, and an optical disk drive interface 274, respectively. The drives and their associated computer-readable media provide nonvolatile storage of computer-readable instructions, data structures, program modules and other data for the personal computer 260. Although the exemplary environment described herein employs a hard disk, a removable magnetic disk 269, and a removable optical disk 271, it will be appreciated by those skilled in the art that other types of computer-readable media which can store data that is accessible by a computer, such as magnetic cassettes, flash memory cards, digital video disks, Bernoulli cartridges, random access memories, read only memories, and the like may also be used in the exemplary operating environment.

A number of program modules may be stored on the hard disk, magnetic disk 269, optical disk 271, ROM 264 or RAM 265, including an operating system 275, one or more applications programs 276, other program modules 277, and program data 278. A user may enter commands and information into the personal computer 260 through input devices such as a keyboard 280 and a pointing device 282. Other input devices (not shown) may include a microphone, joystick, game pad, satellite dish, scanner, or the like. These and other input devices are often connected to the processing unit 261 through a serial port interface 286 that is coupled to the system bus, but may be connected by other interfaces, such as a parallel port, game port or a universal serial bus (USB). A monitor 287 or other type of display device is also connected to the system bus 263 via an interface, such as a video adapter 288. In addition to the monitor, personal computers typically include other peripheral output devices, not shown, such as speakers and printers.

Although the client system 260 is described in the context of being a personal computer, one of ordinary skill in the art will readily recognize that the client system 260 could be any of a variety of systems. For example, the client system 260 could be a mobile phone, a personal digital assistant or any of a variety of devices capable of receiving data transmissions from the database 240.

The client system 260 includes a graphical user interface (GUI). A GUI is a graphics-based user interface that incorporates movable windows, icons and a mouse. The ability to resize application windows and change style and size of fonts are the significant advantages of a GUI vs. a character-based interface. GUIs have become the standard way users interact with a computer. In an embodiment, the GUI is employed to configure the client system 260 to receive data transmissions from the database 240.

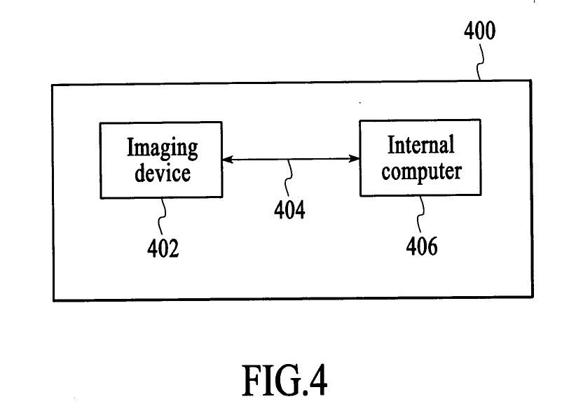

In an embodiment, the data capturing system 210 includes a satellite-based image capturing system such as a digital camera. For a more detailed description, please refer now to FIG. 4. FIG. 4 shows an illustration of a digital camera 400 in accordance with an embodiment. Digital camera 400 includes an imaging device 402, a system bus 404 and an internal computer 406 whereby the imaging device 402 is electrically coupled to the internal computer 406 via system bus 404. Although the above-described embodiment is a digital camera, one of ordinary skill in the art will readily recognize that any of a variety of image capturing devices can be implemented in conjunction the disclosed embodiments.

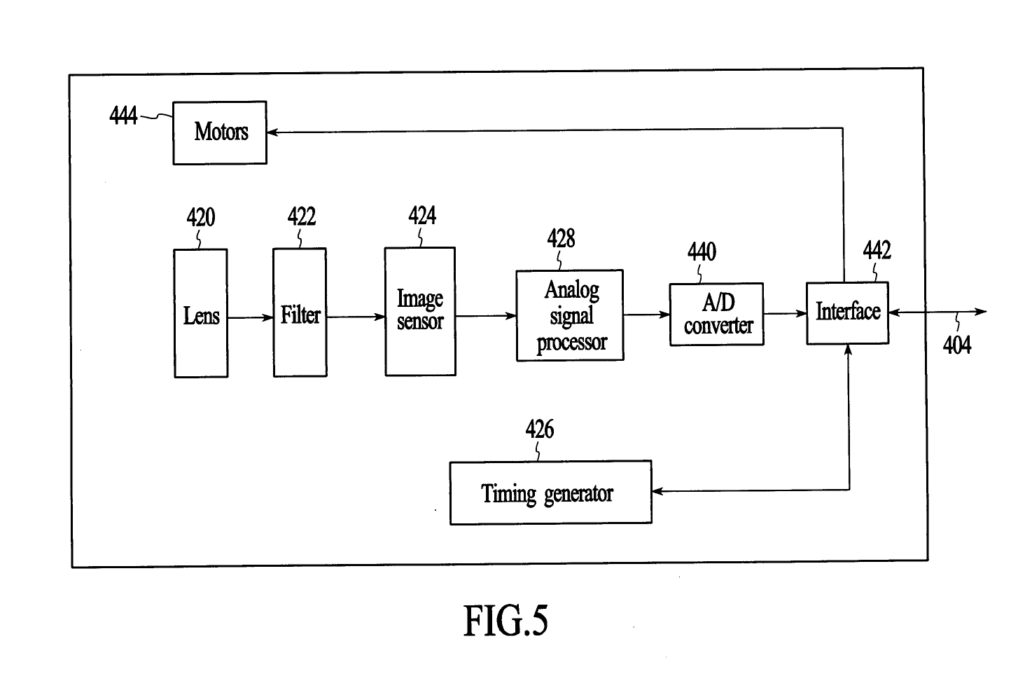

Referring now to FIG. 5, a more detailed block diagram of an embodiment of the imaging device 402 is shown. Imaging device 402 can be a lens 420 having an iris, a filter 422, an image sensor 424, a timing generator 426, an analog signal processor (ASP) 428, an analog-to-signal (A/D) converter 440, an interface 442 and one or more motors 444.

In operation, imaging device 402 captures an image of an object via reflected light impacting image sensor 424. Image sensor 424 responsively generates a set of raw image data representing the captured image. The raw image data can ten be routed through ASP 428, A/D converter 440 and interface 442. Interface 442 has outputs for controlling ASP 428, motors 444 and timing generator 426. From interface 442, the raw image data passes over system bus 404 to the internal computer 406.

In an embodiment, the digital camera 400 is configured to capture and transmit image data to the database 240 in response to an event trigger from the impact sensory system 220. The impact sensory system 220 includes one or more crash event sensors that are attached to the vehicle 250 for detecting the occurrence of the vehicle crash event. For example, the crash event sensor may be an inertia sensing device, a crush sensing device, and/or an acceleration sensing device. When the crash event sensor or sensors detect the occurrence of a crash event, one or more occupant protection devices (e.g. a vehicular airbag deployment system) are actuated to help protect one or more vehicle occupants.

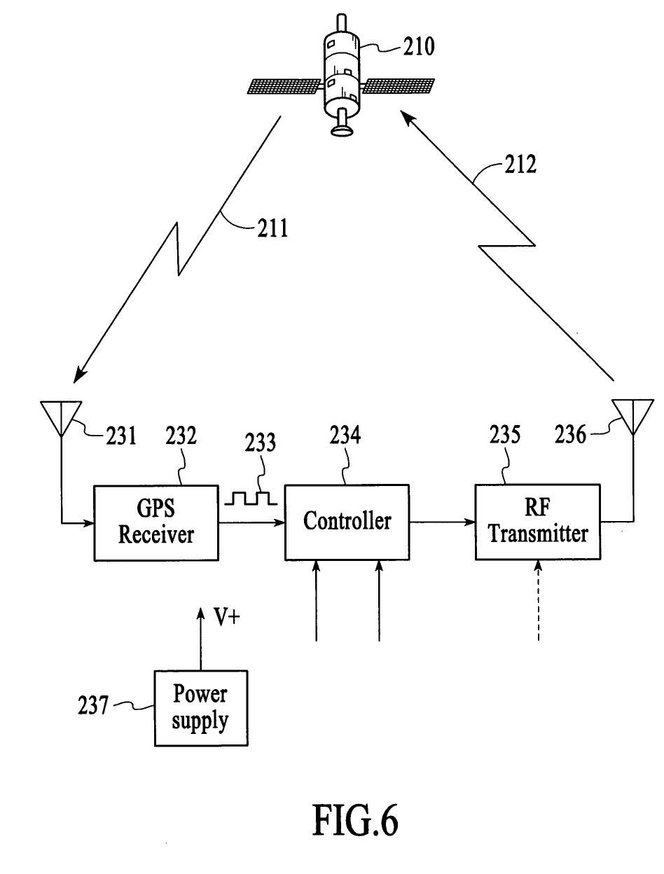

As previously mentioned, the system 200 also includes a global positioning system (GPS) 230. For a more detailed description of the GPS 230, please refer to FIG. 6. FIG. 6 shows a more detailed description of a GPS 230 in accordance with an embodiment. The system includes the GPS satellite 210, a GPS receiving antenna 231, GPS receiver 232, a controller 234, an RF transmitter 235, a GPS transmission antenna 236 and a power supply 237.

During operation, the GPS satellite 210 outputs a GPS signal 211, whereby the GPS receiving antenna 231 receives at the GPS signal 211 from the GPS satellite 210. The signal 211 is input to the GPS receiver 232. The GPS receiver 232 triangulates the GPS signals 211 into a location signal string 233. The emergency location signal string 233 is input to the controller 234. The controller 234 provides output to the RF transmitter 235, whereby that output is transmitted through the RF antenna 236. The RF antenna 236 subsequently outputs a signal 226 to the GPS satellite 210. Accordingly, by utilizing the GPS, the system 200 can transmit the location, the speed of the vehicle 250, as well as the date and time of an accident in response to the impact sensory system 220.

Accordingly, referring back to FIG. 2, during the operation of the system 200, when the vehicle 250 is involved in an accident, the impact sensory system 220 transmits a signal to the satellite 210. Upon receipt of the signal, an image capturing device within the satellite 210 begins capturing images of the accident. Simultaneously, the GPS 230 transmits the location of the vehicle 250 to a processing engine within the satellite 210. The images, the date, time and location of the accident are then recorded by the processing engine. This information is then transmitted to the database 240. Finally, the database 240 transmits this info to the client system(s) 260 (e.g. insurance carrier, consumer, etc.) via email over the network 245 or any other of a variety of suitable transmittable means.

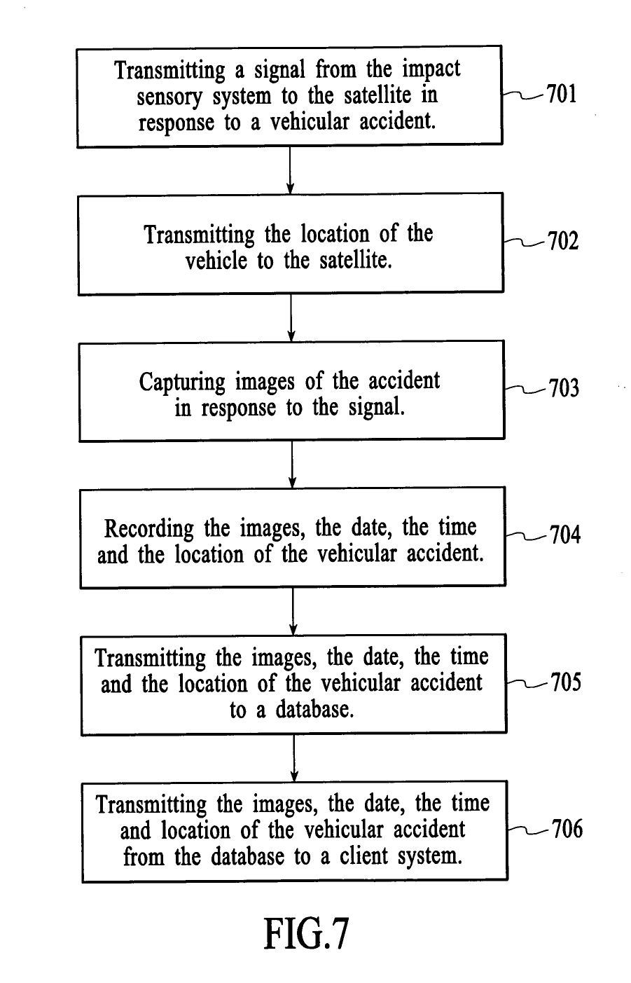

For a better understanding of the above-described embodiment, please refer to FIG. 7. FIG. 7 is a flowchart of the operation of the system in accordance with an embodiment. A first step 701 includes transmitting a signal from the impact sensory system to the satellite in response to a vehicular accident. A next step 702 includes transmitting the location of the vehicle to the satellite. A third step 703 includes capturing images of the accident in response to the signal. A fourth step 704 includes recording the images, the date, the time and location of the accident. A fifth step 705 includes transmitting the images, the date, the time and location of the accident to a database. A final step 706 includes transmitting the images, the date, time and location of the accident to the client system.

Although the above-described embodiment involves a satellite based image capturing device, the inventive concept is not limited thereto. One of ordinary skill in the art will readily recognize that one or more image capturing devices could be configured on the vehicle 250 in order to simultaneously capture images of the accident from an alternate perspective.

The above-described embodiment(s) may also be implemented, for example, by operating a computer system to execute a sequence of computer readable instructions. Accordingly, computing device 260 typically includes at least some form of computer readable media. Computer readable media can be any available media that can be accessed by computing device 260. By way of example, and not limitation, computer readable media may comprise computer storage media and communications media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage device, or any other medium which can be used to store the desired information and which can be accessed by computing device 260.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Accordingly, an alternate embodiment includes a computer readable medium having computer executable components for reporting information related to a vehicular accident wherein the vehicular accident involves at least one vehicle.

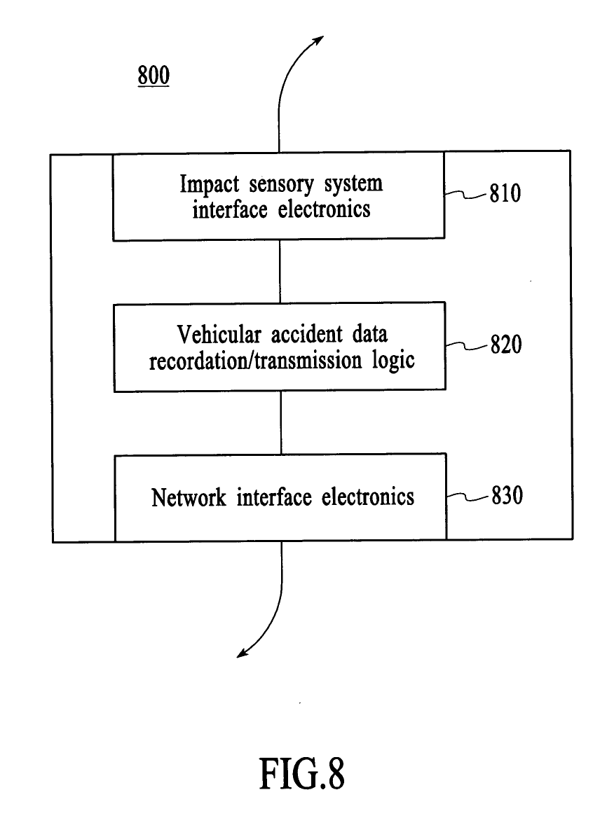

Additionally, another contemplated embodiment involves a vehicular accident reporting module that may be implemented as one or more respective software modules operating in the satellite 210. In accordance with an embodiment, the accident reporting module controls the relevant components of the system 200. FIG. 8 shows a more detailed illustration of the accident reporting module 800 in accordance with an embodiment. The accident reporting module 800 includes impact sensory system interface electronics 810, vehicular accident data recordation/transmission logic 820, network interface electronics 830. The impact sensory system interface electronics 810 are coupled to the vehicular accident data recordation logic 820 wherein the vehicular accident data recordation logic 820 is further coupled to the network interface electronics 830.

Although the components of the above-described accident reporting module 800 are shown in a specific configuration, one of ordinary skill in the art will readily recognize the components of the accident reporting module 800 could be configured in a variety of ways while remaining within the spirit and scope of the described embodiment.

The impact sensory system interface electronics 810 and the network interface electronics 830 include the electronic circuitry employed by the accident reporting module 220 to respectively communicate with the impact sensory system 220 and the communications network 245. Vehicular accident data recordation/transmission logic 820 contains logic for recording and transmitting data to and from the network 245.

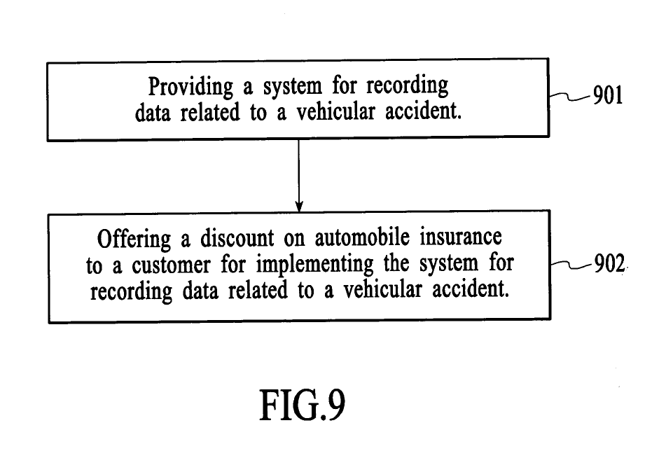

Furthermore, an alternate embodiment includes a method of providing automobile insurance to a consumer. FIG. 9 shows a flowchart of a business method in accordance with an embodiment. A first step 901 includes providing a system for recording data related to a vehicular accident. In an embodiment, the vehicular accident includes at least one vehicle and the system includes a data capturing system, an impact sensory system and a database coupled to the data capturing system for receiving the data related to the vehicular accident. A second step 902 includes offering a discount on automobile insurance to a consumer for implementing the system for recording data related to a vehicular accident.

Based on varying embodiments of the present invention, a system and method of recording data related to a vehicular accident are disclosed. As a result, vital data and images of a vehicular accident are expeditiously recorded in real time and with high resolution. Consequently, a more accurate account of the vehicular accident is generated thereby resulting in less accident related litigation for insurance companies. This accordingly translates to lower insurance premiums for the consumer.

Without further analysis, the foregoing so fully reveals the gist of the present invention that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

What we claim is:

1. A method of reporting information related to a vehicular accident wherein the vehicular accident involves at least one vehicle, the method comprising:
capturing images of the vehicular accident with an image capturing device in response to an event trigger in a real time fashion; and
transmitting the images to a database.

2. The method of claim 1 wherein the event trigger comprises the activation of a sensor located within the at least one vehicle.

3. The method of claim 1 wherein the act of transmitting the images to a database further comprises:
transmitting the images to at least one recipient via a server coupled to the database in a real time fashion.

4. The method of claim 1 wherein the at least one vehicle further comprises a global positioning system (GPS) and the act of capturing images of the vehicular accident with an image capturing device further comprises:
accessing the GPS; and
recording a location of the accident, a date of the accident, a time of the accident and a speed of the at least one vehicle.

5. The method of claim 1 wherein the image capturing device further comprises a satellite-based image capturing device.

6. The method of claim 2 wherein the sensor further comprises an air bag deployment sensor.

7. The method of claim 2 wherein the sensor further comprises an impact sensor.

8. A system for recording data related to a vehicular accident wherein the vehicular accident includes at least one vehicle, the system comprising:
a data capturing system;
an impact sensing system located in the at least one vehicle wherein the impact sensing system is capable of communicating with the data capturing system; and
a database coupled to the data capturing system for receiving the data related to the vehicular accident.

9. The system of claim 8 wherein the at least one vehicle further comprises a GPS capable of communicating with the data capturing system.

10. The system of claim 8 wherein the data capturing system is a satellite based image capturing system.

11. The system of claim 8 wherein the database is coupled to an offsite server.

12. The system of claim 8 wherein the impact sensing system further comprises an event triggering mechanism for triggering the data capturing system.

13. The system of claim 12 wherein the offsite server is configured to transmit the data related to the vehicular accident to at least one recipient in a real time fashion.

14. A computer program product for reporting information related to a vehicular accident wherein the vehicular accident involves at least one vehicle, the computer program product comprising a computer usable medium having computer readable program means for causing a computer to perform the acts:
capturing images of the vehicular accident with an image capturing device in response to an event trigger in a real time fashion; and
transmitting the images to a database.

15. The computer program product of claim 14 wherein the act of transmitting the information to a database further comprises:
transmitting the images to at least one recipient via a server coupled to the database in a real time fashion.

16. The computer program product of claim 14 wherein the at least one vehicle further comprises a global positioning system (GPS) and the act of capturing images of the vehicular accident further comprises:
accessing the GPS; and
recording a location of the accident, a date of the accident, a time of the accident and a speed of the at least one vehicle.

17. A vehicular accident reporting module comprising:
vehicular accident data recordation logic for:
capturing images of the vehicular accident in response to an event trigger; and
transmitting the images to a database in a real time fashion.

18. The vehicular accident reporting module of claim 17 wherein the event trigger comprises the activation of a sensor located within the at least one vehicle.

19. The vehicular accident reporting module of claim 17 wherein the act of transmitting the images to a database further comprises:
transmitting the images to at least one recipient via a server coupled to the database in a real time fashion.

20. The vehicular accident reporting module of claim 17 wherein at least one vehicle in the vehicular accident further comprises a GPS and the act of capturing images of the vehicular accident further comprises:
accessing the GPS; and
recording a location of the vehicular accident, a date of the accident, a time of the accident and a speed of the at least one vehicle.

21. A method of providing automobile insurance to at least one consumer comprising:
providing a system for recording data related to a vehicular accident wherein the vehicular accident includes at least one vehicle, the system comprising;
a data capturing system;
an impact sensing system located in the at least one vehicle wherein the impact sensing system is capable of communicating with the data capturing system; and
a database coupled to the data capturing system for receiving the data related to the vehicular accident; and
offering a discount on automobile insurance to the at least one consumer for implementing the system for recording data related to a vehicular accident.

22. A method of reporting information related to a vehicular accident wherein the vehicular accident involves at least one vehicle, the method comprising:
transmitting a signal from an impact sensory system within the at least one vehicle to a satellite system in response to the vehicular accident;
transmitting a location of the at least one vehicle to a satellite;
capturing images of the vehicular accident in response to the signal;
recording the images, a date, a time and a location of the vehicular accident;
transmitting the images, the date, the time and location of the accident to a database; and
transmitting the images, the date, time and location of the vehicular accident to a client system coupled to the database.
